(19) United States
(12) Patent Application Publication
(10) Pub. No.: US 2017/0133129 A1
(43) Pub. Date: May 11, 2017

(54) METHOD OF USING CARBON NANOTUBES TO FABRICATE TRANSPARENT CONDUCTIVE FILM

(71) Applicant: TAIWAN CARBON NANO TECHNOLOGY CORPORATION, MIAOLI COUNTY (TW)

(72) Inventors: Chun-Hsien Tsai, MIAOLI COUNTY (TW); Ting-Chuan Lee, MIAOLI COUNTY (TW); Chun-Jung Tsai, MIAOLI COUNTY (TW); Ching-Tung Hsu, MIAOLI COUNTY (TW); Chia-Hung Li, MIAOLI COUNTY (TW); Jui-Yu Jao, MIAOLI COUNTY (TW)

(21) Appl. No.: 15/414,134

(22) Filed: Jan. 24, 2017

Related U.S. Application Data
(62) Division of application No. 14/565,023, filed on Dec. 9, 2014.

(30) Foreign Application Priority Data
Jun. 4, 2014 (TW) 103119336

(51) Int. Cl. H01B 13/00; H01B 1/12; B23K 1/00

(52) U.S. Cl. CPC H01B 13/0016; B23K 1/0008; H01B 1/12; B23K 2201/38

(57) ABSTRACT

A method of using carbon nanotubes to fabricate a transparent conductive film comprising steps: disposing a plurality of carbon nanotubes and a plurality of metallic particles on a substrate; illuminating the carbon nanotubes with a light beam or treating the carbon nanotubes with electric corona to induce photocurrents or discharge currents in the carbon nanotubes; and heating and melting the metallic particles with the photocurrents or the discharge currents to solder the metallic particles with the carbon nanotubes and form a transparent conductive film on the substrate. The present invention uses a light illumination or an electric corona treatment to reliably connect the carbon nanotubes by the metallic particles and increase the conductivity of the transparent conductive film.

### CROSS-REFERENCE TO RELATED APPLICATIONS

This application is a Divisional of co-pending application Ser. No. 14/565,023 filed on Dec. 9, 2014, for which priority is claimed under 35 U.S.C. §120; and this application claims priority of Application No. 103119336 filed in Taiwan, R.O.C. on Jun. 4, 2014 under 35 U.S.C. §119; the entire contents of all of which are hereby incorporated by reference.

### FIELD OF THE INVENTION

The present invention relates to a method of fabricating a conductive film, particularly to a method of using carbon nanotubes to fabricate a transparent conductive film.

### BACKGROUND OF THE INVENTION

With prevalence of flat panel displays and touch panels, the transparent conductive film thereof is also being improved and upgraded by the related manufacturers. At present, the transparent conductive film is mainly made of indium tin oxide (ITO). Indium is a rare metal whose production is very limited. Thus, indium supply is unstable, and indium price is growing higher. Therefore, the related manufacturers are eager to develop substitute materials.

For example, carbon nanotube has been used to fabricate conductive films because of its electric conductivity. The conventional carbon nanotube-based conductive film includes a carbon nanotube network. However, the conventional carbon nanotube-based conductive film has lower electric conductivity because of the meshes of the carbon nanotube network.

A Taiwan Patent publication No. 201137899 disclosed a conductive film comprising a carbon nanotube network layer and a plurality of conductive nanoparticles, wherein the carbon nanotube network layer has a plurality of meshes, and the conductive nanoparticles are filled into the meshes, whereby the conductivity of the conductive film is increased.

Although the prior art fills conductive nanoparticles into the meshes of the carbon nanotube network, the carbon nanotubes thereof do not connect to each other reliably but only overlap or touch mechanically. Thus, the prior art cannot yet break through the bottleneck of low conductivity and still has room to improve.

### SUMMARY OF THE INVENTION

The primary objective of the present invention is to solve the problem: the carbon nanotube-based conductive film fabricated in the conventional technology lacks a reliable connection between carbon nanotubes and thus has a poor conductivity.

In order to achieve the abovementioned objective, the present invention proposes a method of using carbon nanotubes to fabricate a transparent conductive film, which comprises the following steps of:

Step 1: disposing a plurality of carbon nanotubes and a plurality of metallic particles on a substrate;

Step 2: illuminating the carbon nanotubes with light to induce photocurrents in the carbon nanotubes; and

Step 3: heating and melting the metallic particles with the photocurrents to solder the metallic particles and the carbon nanotubes and form a transparent conductive film on the substrate.

The present invention further proposes another method of using carbon nanotubes to fabricate a transparent conductive film, which comprises the following steps of:

Step A: disposing a plurality of carbon nanotubes and a plurality of metallic particles on a substrate;

Step B: treating the carbon nanotubes with electric corona to induce discharge currents in carbon nanotubes; and

Step C: heating and melting the metallic particles with the discharge currents to solder the metallic particles and the carbon nanotubes and form a transparent conductive film on the substrate.

In summary, the present invention threats carbon nanotubes with light illumination or electric corona to melt metallic particles between the carbon nanotubes and solder the metallic particles and the carbon nanotubes, whereby reliable connections are created between the carbon nanotubes, and whereby the conductivity of the transparent conductive film is increased.

### BRIEF DESCRIPTION OF THE DRAWINGS

FIG. 1 shows a flowchart of a method of using carbon nanotubes to fabricate a transparent conductive film according to a first embodiment of the present invention.

FIGS. 2A-2C are diagrams schematically showing the steps of a method of using carbon nanotubes to fabricate a transparent conductive film according to the first embodiment of the present invention.

FIG. 3 shows a flowchart of a method of using carbon nanotubes to fabricate a transparent conductive film according to a second embodiment of the present invention.

FIGS. 4A-4C are diagrams schematically showing the steps of a method of using carbon nanotubes to fabricate a transparent conductive film according to the second embodiment of the present invention.

### DETAILED DESCRIPTION OF THE PREFERRED EMBODIMENTS

The technical contents of the present invention will be described in detail in cooperation with drawings below.

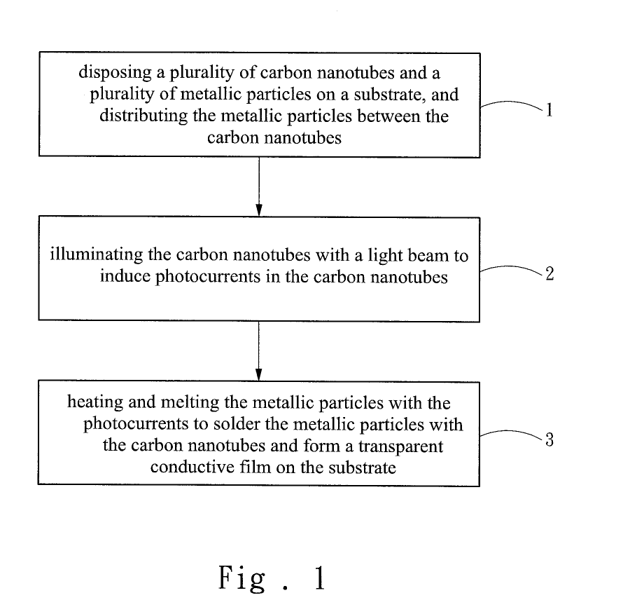

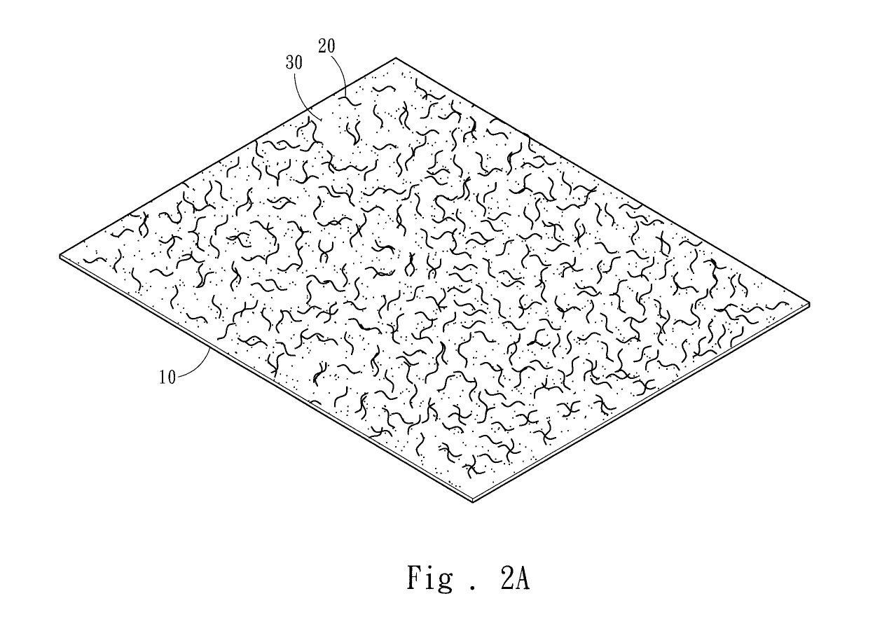

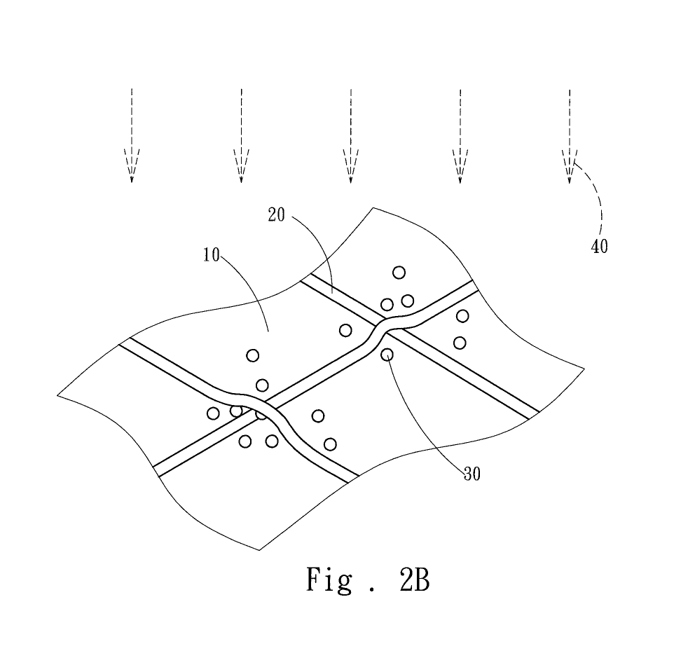

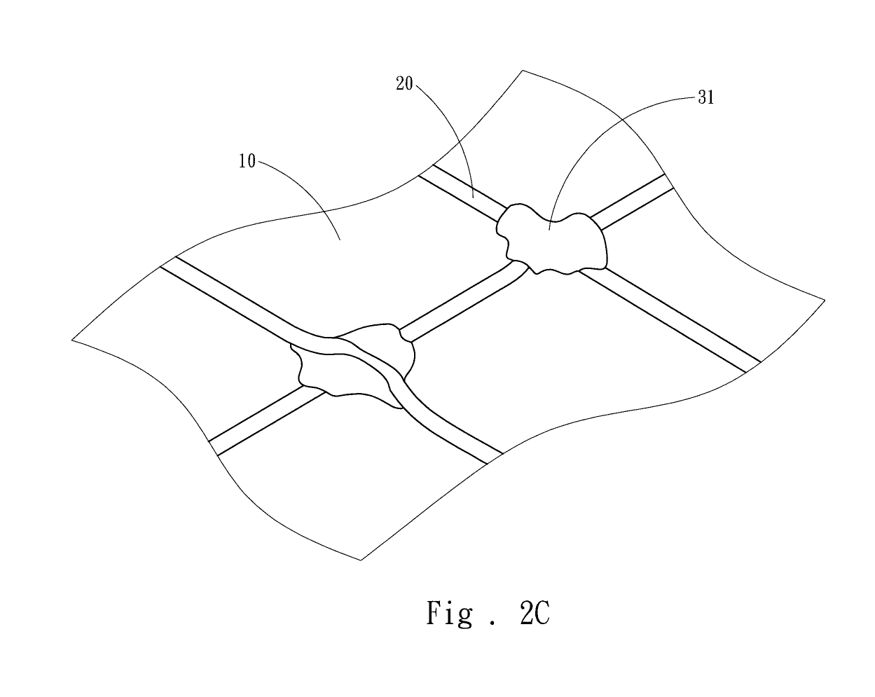

Refer to FIG. 1 and FIGS. 2A-2C. FIG. 1 shows a flowchart of a method of using carbon nanotubes to fabricate a transparent conductive film according to a first embodiment of the present invention. FIGS. 2A-2C are diagrams schematically showing the steps of a method of using carbon nanotubes to fabricate a transparent conductive film according to the first embodiment of the present invention. In the first embodiment, the method of the present invention comprises Steps 1-3.

In Step 1, dispose a plurality of carbon nanotubes 20 and a plurality of metallic particles 30 on a substrate 10, as shown in FIG. 2A. The metallic particles 30 are distributed between the carbon nanotubes 20. The carbon nanotubes 20 have a length of 5 nm-1 mm. The metallic particles 30 is made a material selected from a group consisting of silver, tin, copper, gold, aluminum, tungsten, iron, platinum, lead, manganese, nickel, indium, and alloys thereof. The metallic particles 30 have a diameter of 1 nm-100 nm. In the first embodiment, the substrate 10 is a film made of polyethylene terephthalate (PET). However, the present invention does not limit that the substrate 10 must be made of PET. The substrate 10 may also made of a material selected from a group consisting of glass, polymethylmethacrylate (PMMA), polychloroprene (PC), acrylic, polypropylene (PP), polystyrene (PS), polyethylene (PE), acrylonitrile butadiene styrene (ABS), and ethylene vinyl acetate (EVA). The substrate 10 is to sustain the carbon nanotubes 20 and the metallic particles 30, preferably a transparent one. In the first embodiment, the carbon nanotubes 20 and the metallic particles 30 are mixed with a solvent to form a solution or a paste. The solution or the paste is spread on the substrate 10, and the solvent will evaporate later. The solvent may be selected from a group consisting of water, butyl acetate, and N-methyl-2-pyrrolidone (NMP). In one embodiment, the mixture of the carbon nanotubes 20 and the metallic particles 30 is directly spread on the substrate 10. In one embodiment, the carbon nanotubes 20 are formed on the substrate 10, and then the metallic particles 30 are sprayed to the positions between the carbon nanotubes 20.

In Step 2, illuminate the carbon nanotubes 20 with light to induce photocurrents in the carbon nanotubes 20, as shown in FIG. 2B. In the first embodiment, the carbon nanotubes 20 are illuminated with a laser device or a light diffuser. The laser device or the light diffuser emits a light beam 40 having a wavelength of 390 nm-3000 nm, and photons thereof have energy of 0.41 eV-3.18 eV. The photons of the light beam 40 will excite the electrons of the carbon nanotubes 20 to a conduction band, and photocurrents are thus generated. For the principle of inducing photocurrents, refer to a paper “Photocurrent Amplification at Carbon Nanotube” proposed by Der-Hsien Lien, Wen-Kuang Hsu, Hsiao-Wen Zan,Nyan-Hwa Tai, and

Chuen-Horng Tsai, in Metal Contacts, Adv. Mater. 2006, 18, 98-103. The method recorded in the paper is included by the specification and regarded as a portion of the present invention.

In Step 3, heat and melt the metallic particles 30 with the photocurrents to solder the metallic particles 30 with the carbon nanotubes 20 and form a transparent conductive film on the substrate 10, as shown in FIG. 2C. The contacts between the carbon nanotubes 20 have higher resistance and are heated to a high temperature while the photocurrents flow in the carbon nanotubes 20. The high temperature will heat the metallic particles 30 to the melting point. Then, the melted metallic particles 30 function as a solder 31 to solder the carbon nanotubes together. Thus, the gaps of the contacts between the carbon nanotubes 20 disappear, and the resistance of the contact areas decreases. Hence, the temperature of the contact areas is lowered, and the solder 31 solidifies to connect the carbon nanotubes 20 reliably. Thereby is formed a transparent conductive film on the substrate 10. In the first embodiment, the metallic particles 30 are heated to a temperature of 750-1000° C. In the first embodiment, the metallic particles 30 are made of silver, which has a melting point of about 962° C. Then, the transparent conductive film is taken off from the substrate 10.

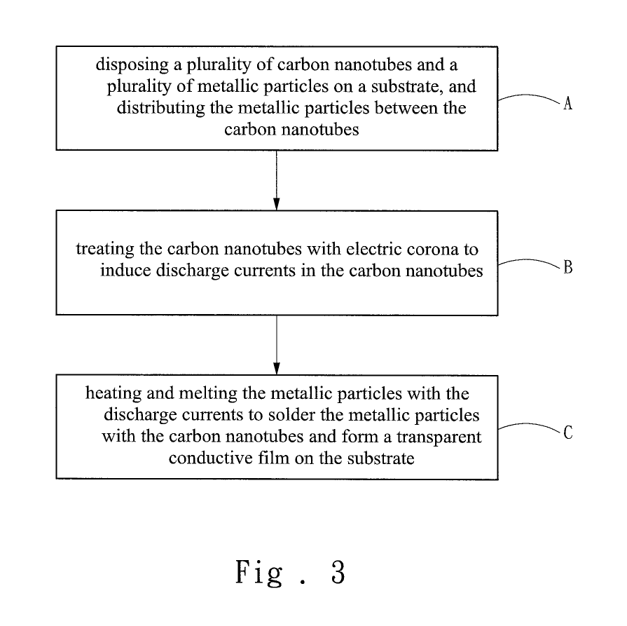

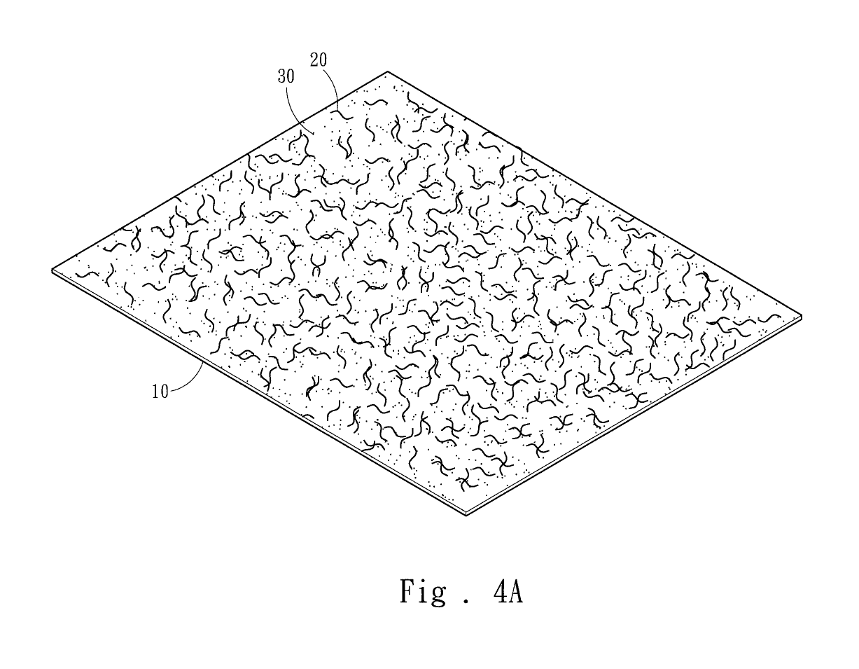

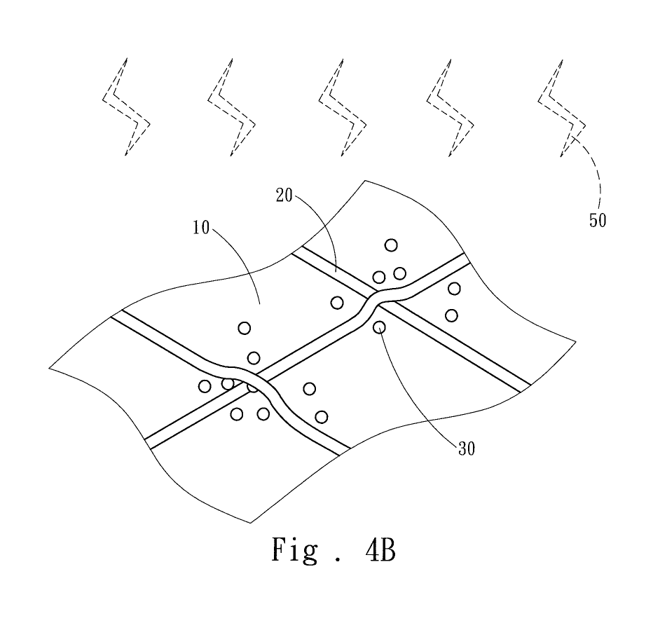

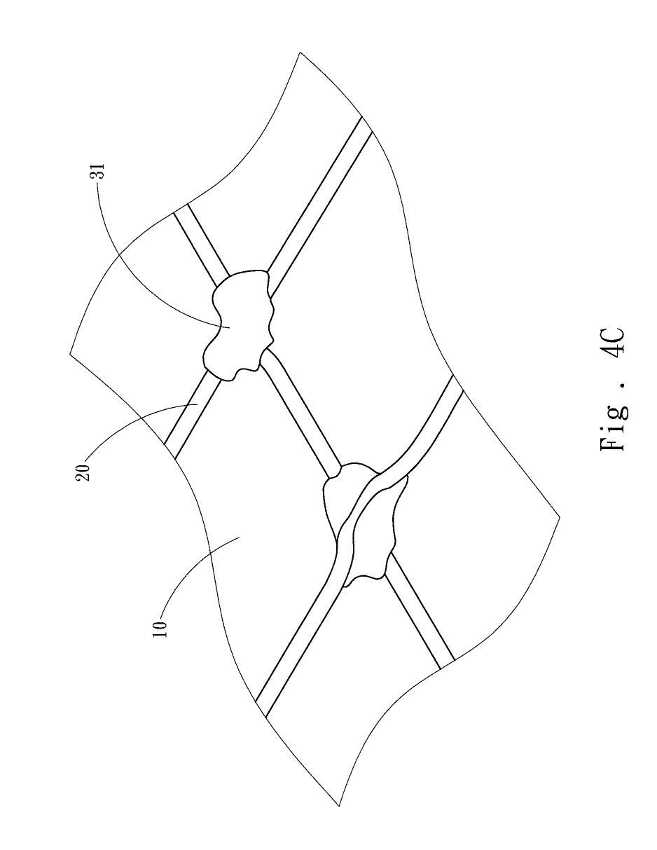

Refer to FIG. 3 and FIGS. 4A-4C. FIG. 3 shows a flowchart of a method of using carbon nanotubes to fabricate a transparent conductive film according to a second embodiment of the present invention. FIGS. 4A-4C are diagrams schematically showing the steps of a method of using carbon nanotubes to fabricate a transparent conductive film according to the second embodiment of the present invention. In the second embodiment, the method of the present invention comprises Steps A-C.

In Step A, dispose a plurality of carbon nanotubes 20 and a plurality of metallic particles 30 on a substrate 10, as shown in FIG. 4A. Step A of the second embodiment is identical to Step 1 of the first embodiment. Therefore, the details thereof will not repeat herein.

In Step B, treat the carbon nanotubes 20 with electric corona to induce discharge currents in the carbon nanotubes 20, as shown in FIG. 4B. The electric corona treatment is to inject a plurality of high-energy electrons 50 or high-energy ions 50 into the carbon nanotubes 20 to induce the discharge currents in the carbon nanotubes 20. In the second embodiment, the substrate 10 together with the carbon nanotubes 20 and the metallic particles 30 carried by the substrate 10 is placed in an atmosphere, and plasma is generated in the atmosphere to undertake the electric corona treatment of the carbon nanotubes 20. In the second embodiment, the atmosphere has a pressure of 0-1 atm, and the plasma is argon plasma. In Step C, heat and melt the metallic particles 30 with the discharge currents to solder the metallic particles 30 with the carbon nanotubes 20 and form a transparent conductive film on the substrate 10, as shown in FIG. 4C. Similarly to the first embodiment, the contacts between the carbon nanotubes 20 have higher resistance and are heated to a high temperature while the discharge currents flow in the carbon nanotubes 20. The high temperature will heat the metallic particles 30 to the melting point. Then, the melted metallic particles 30 function as a solder 31 to solder the carbon nanotubes together. Thus, the gaps of the contacts between the carbon nanotubes 20 disappear, and the resistance of the contact areas decreases. Hence, the temperature of the contact areas is lowered, and the solder 31 solidifies to connect the carbon nanotubes 20 reliably. Thereby is formed a transparent conductive film on the substrate 10. In the second embodiment, the metallic particles 30 are heated to a temperature of 750-1000° C. In the second embodiment, the metallic particles 30 are made of silver, which has a melting point of about 962° C. Then, the transparent conductive film is taken off from the substrate 10.

In conclusion, the present invention uses a light illumination or an electric corona treatment to melt the metallic particles distributed between the carbon nanotubes and solder the metallic particles with the carbon nanotubes, whereby the carbon nanotubes are connected reliably, and whereby the conductivity of the transparent conductive film is increased. The light illumination and electric corona treatment used by the present invention can fast fabricate a large-area uniform transparent conductive film in a low cost. Therefore, the present invention has significant improvement over the conventional technology. Accordingly, the present invention possesses utility, novelty and non-obviousness and meets the condition for a patent. Thus, the Inventors file the application for a patent. It is appreciated if the patent is approved fast.

The present invention has been demonstrated in detail with the embodiments. However, it should be noted: these embodiments are only to exemplify the present invention but not to limit the scope of the present invention. Any equivalent modification or variation according to the spirit of the present invention is to be also included within the scope of the present invention.

What is claimed is:

1. A method of using carbon nanotubes to fabricate a transparent conductive film, comprising the following steps of:
Step A: disposing a plurality of carbon nanotubes and a plurality of metallic particles on a substrate;
Step B: treating the carbon nanotubes with electric corona to induce discharge currents in the carbon nanotubes; and
Step C: heating and melting the metallic particles with the discharge currents to solder the metallic particles with the carbon nanotubes and form a transparent conductive film on the substrate.

2. The method of using carbon nanotubes to fabricate a transparent conductive film according to claim 1, wherein in Step A, the carbon nanotubes have a length of 5 nm-1 mm.

3. The method of using carbon nanotubes to fabricate a transparent conductive film according to claim 1, wherein in Step A, the metallic particles have a diameter of 1 nm-100 nm.

4. The method of using carbon nanotubes to fabricate a transparent conductive film according to claim 1, wherein in Step A, the substrate is made of a material selected from a group consisting of polyethylene terephthalate (PET), glass, polymethylmethacrylate (PMMA), polychloroprene (PC), acrylic, polypropylene (PP), polystyrene (PS), polyethylene (PE), acrylonitrile butadiene styrene (ABS), and ethylene vinyl acetate (EVA).

5. The method of using carbon nanotubes to fabricate a transparent conductive film according to claim 1, wherein in Step A, the metallic particles is made of a material selected from a group consisting of silver, tin, copper, gold, aluminum, tungsten, iron, platinum, lead, manganese, nickel, indium, and alloys thereof.

6. The method of using carbon nanotubes to fabricate a transparent conductive film according to claim 1, wherein in Step C, the metallic particles are made of silver, and the metallic particles are heated to a temperature of 750-1000° C.
